(19) United States
(12) Patent Application Publication
(10) Pub. No.: US 2011/0064281 A1
(43) Pub. Date: Mar. 17, 2011

(54) PICTURE SHARING METHODS FOR A PORTABLE DEVICE

(75) Inventor: Cheng-Che Chan, Hsinchu County (TW)

(73) Assignee: MEDIATEK INC., Hsin-Chu (TW)

(21) Appl. No.: 12/793,737

(22) Filed: Jun. 4, 2010

Related U.S. Application Data
(60) Provisional application No. 61/242,464, filed on Sep. 15, 2009.

(51) Int. Cl. G06K 9/00; G06F 3/041

(52) U.S. Cl. 382/118; 345/173

(57) ABSTRACT

A picture sharing method for a portable device is provided. First, a picture to be shared is retrieved. A face recognition procedure is then performed on the picture to recognize at least one facial image in the picture. Thereafter, personal information corresponding to the recognized facial image is obtained. Next, the picture is transmitted to at least one specific network location according to the obtained personal information via a network.

### CROSS REFERENCE TO RELATED APPLICATIONS

This application claims priority of U.S. Provisional Application No. 61/242,464, filed on Sep. 15, 2009, the entirety of which is incorporated by reference herein.

### BACKGROUND OF THE INVENTION

1. Field of the Invention

The invention relates to picture sharing methods, and more particularly to picture sharing methods for a portable device with a face recognition function and a network function.

2. Description of the Related Art

With convenience of portable devices, such as mobile phones, smart phones, and personal digital assistants (PDAs), traveling with portable devices has become a commonality. Meanwhile, some functions of portable devices, such as image capturing and face recognition, are becoming more and more popular. Conventionally, when a user wants to share pictures with other users, the user has to download a picture from a storage device of the portable device and manually upload the picture to a shared space or send the picture to others. The conventional method is inconvenient and time-consuming for users.

### BRIEF SUMMARY OF THE INVENTION

Picture sharing methods for a portable device are provided. An exemplary embodiment of a picture sharing method for a portable device is provided. First, a picture to be shared is retrieved. A face recognition procedure is then performed on the picture to recognize at least one facial image in the picture. Thereafter, personal information corresponding to the recognized facial image is obtained. Next, the picture is transmitted to at least one specific network location according to the obtained personal information via a network.

Moreover, an exemplary embodiment of a portable device comprises a face recognition module, a processing module and a network module. The face recognition module performs a face recognition procedure to recognize at least one facial image in a picture to be shared. The processing module obtains personal information corresponding to the recognized facial image. The network module transmits the picture to at least one specific network location according to the obtained personal information via a network.

Furthermore, an exemplary embodiment of a picture sharing method for a portable device connected to a network is provided. First, a picture is acquired by an image capture module. A face recognition procedure is then performed on the picture to recognize at least one facial image in the picture. Thereafter, personal information corresponding to the recognized facial image is obtained. Next, the picture is transmitted to at least one specific network location according to the obtained personal information via the network.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram illustrating a portable device according to an embodiment of the invention;

FIG. 2 is a schematic diagram illustrating a user interface for editing personal information according to an embodiment of the invention;

FIG. 3 is a flow chart showing an embodiment of a picture sharing method according to the invention;

FIG. 4 is a schematic diagram illustrating a displayed picture with recognized facial images according to another embodiment of the invention; and

FIG. 5 is a flow chart showing another embodiment of a picture sharing method according to the invention.

### DETAILED DESCRIPTION OF THE INVENTION

The following description is of the best-contemplated mode of carrying out the invention. The description is made for the purpose of illustrating the general principles of the invention and should not be taken in a limiting sense. The scope of the invention is best determined by reference to the appended claims.

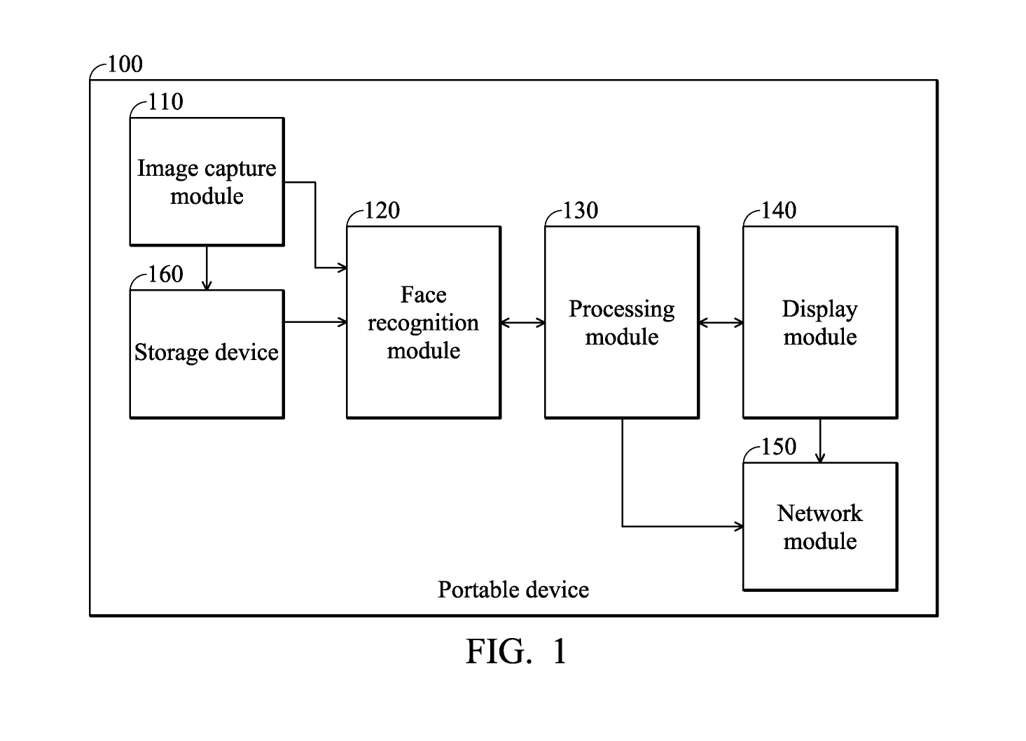

FIG. 1 is a schematic diagram illustrating a portable device 100 according to an embodiment of the present invention. It is understood that the mobile phone is used in the embodiments, but is not limited thereto. For example, the portable device 100 may be a personal digital assistant (PDA), a digital camera and so on. The portable device 100 may comprise an image capture module 110, a face recognition module 120, a processing module 130, a display module 140, a network module 150 and a storage device 160. The image capture module 110 (e.g. a CCD camera) is capable of capturing a picture and providing a picture to be shared. The face recognition module 120 may perform a face recognition procedure on a picture that contains facial images to locate a match. The face recognition procedure can be performed according to at least one predefined facial image. The face recognition module 120 may acquire a picture to be recognized from the storage device 160 or from the image capture module 110. In some embodiments, at least one of the image capture module 110, the display module 140 and the storage device 160 could be external to the portable device 100, i.e. not included in the portable device 100, but coupled to the portable device 100.

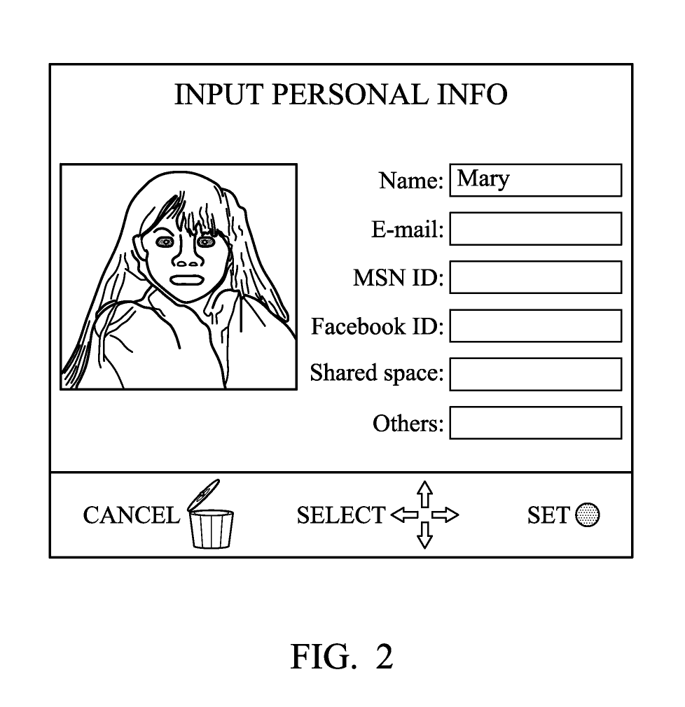

In this embodiment, when performing the face recognition procedure, the face recognition module 120 may first detect at least one facial image in the picture and then determines whether the detected facial image matches one of the predefined facial images of registered users stored in a predefined database, which is also referred to as a facial image database. The facial image database may be stored within the storage device 160 or outside of the storage device 160. The facial image database may comprise a plurality of predefined facial images and the personal information corresponding to the predefined facial images. If a detected facial image matches a predefined facial image in the database, the personal information for the matched facial image, i.e. the recognized facial image, is obtained. Various methods can be used to perform a face recognition procedure to recognize at least one facial image in the picture. In one method, for example, to recognize whether a person in the picture is Mary, following steps may be performed: (1) providing a database which contains facial characteristic data M of Mary; (2) analyzing the facial image x in the picture to obtain a facial characteristic data X corresponding to the facial image x; and (3) comparing the data M with the data X to determine whether the data M matches the data X. In another method, the database may store the facial image of Mary and a similarity comparison may be performed on the facial image of Mary and a facial image X of the picture to recognize whether a person in the picture is Mary. The recognized facial image and the obtained personal information may correspond to a same one of the predefined facial images. The predefined facial images and the personal information can be contained in a same database or in different databases. The personal information may, for example, comprise a tag data for identifying or describing the predefined facial image, such as a name corresponding to the predefined facial image. Therefore, the tag data (e.g. name) can also be obtained for all matched facial images. In some embodiments, the recognized facial image, the obtained personal information and the predefined facial image correspond to a same user. In other embodiments, personal information may belong to a different user from the predefined facial image does. For example, user A may be willing to have pictures containing user B's facial image. Then user A can associate his/her personal information, such as email address or shared space, with user B's predefined facial image. If a picture contains facial image of user B and the facial image is recognized, the picture can be transmitted to at least one specific network location according to user A's personal information. It is to be noted that the device 100 may further provide a user interface for the user to edit personal information including the tag data in advance so that personal information may be used later. FIG. 2 is a schematic diagram illustrating such a user interface for editing personal information according to an embodiment of the invention.

The processing module 130 is coupled to the face recognition module 120 and may combine the picture and located personal information, such as tag data. The display module 140 is coupled to the processing module 130 for displaying the picture containing the recognized facial images with corresponding tag data. For example, each recognized facial image could be displayed with a corresponding name which is displayed close to the recognized facial image, such as a name under a facial image. Therefore, users may easily know who is in the picture. Thereafter, the user may perform further operations to the picture via a user interface. For example, a user may perform an operation to share the picture or view a next picture.

In some embodiment, the user interface may be a touch panel that allows users to select an object or an operation by touching a responsive position on a screen, or the user interface may be a number of keys that can select an object or perform an operation by pressing one or more keys. The user may further edit personal information via the user interface. In this embodiment, editing personal information includes, but not limited to, adding, deleting and modifying personal information. Furthermore, in some embodiments, the obtained personal information can be displayed on the screen for user confirmation. When the picture with the tag data is displayed on the screen, such as a screen of the display module 140, the processing module 130 may further determine whether the picture is to be sent to, for example, other users or friends, or whether a next picture should be viewed. The processing module 130 may further determine whether a recognized facial image is selected. For example, the processing module 130 may determine that a recognized facial image is selected if the touch panel is used and the recognized facial image is touched. It is understood that the user may touch one of the recognized facial images to indicate which person the user would like to share the picture with. In this case, a sharing request may be received when a touch to a portion of the picture corresponding to the recognized facial image on the screen is detected. For example, a user may touch the facial image with the tag data “BOB” to issue a sharing request to share the picture with BOB or any other people. Note that, in this embodiment, the processing module 130 may ignore the sharing request if a facial image other than the recognized facial image is selected. In some embodiments, the picture would not be transmitted when a detected touch to a portion of the picture on the screen does not correspond to any recognized facial image.

Determining that one of the recognized facial images is selected, could mean that the picture is to be shared with other people and thus the processing module 130 may transmit the picture to at least one specific network location according to a predetermined sending setting via the network module 150. The network module 150 could be connected to a network (e.g. Internet) so that it is capable of transmitting data to at least one location in the network. As the personal information corresponding to a facial image in the picture will be obtained when the facial image is recognized, the personal information, such as user names, E-mail addresses, MSN IDs, Facebook IDs, the Blogs, web pages, shared space IPs in the network or a combination thereof, can be known. Therefore, the picture to be shared can be directly sent to a specific selected location via the connected network. The specific network location may be an E-mail address, a Blog, a webpage or a shared space in the network. For example, the picture can be sent to an E-mail address or a shared space, obtained from the personal information, via the Internet. The sending of the shared picture to a selected network location (e.g. an email address of a friend) can be automatically performed in background without affecting subsequent procedures desired by the user.

Picture sharing methods for sharing a picture with other users are provided.

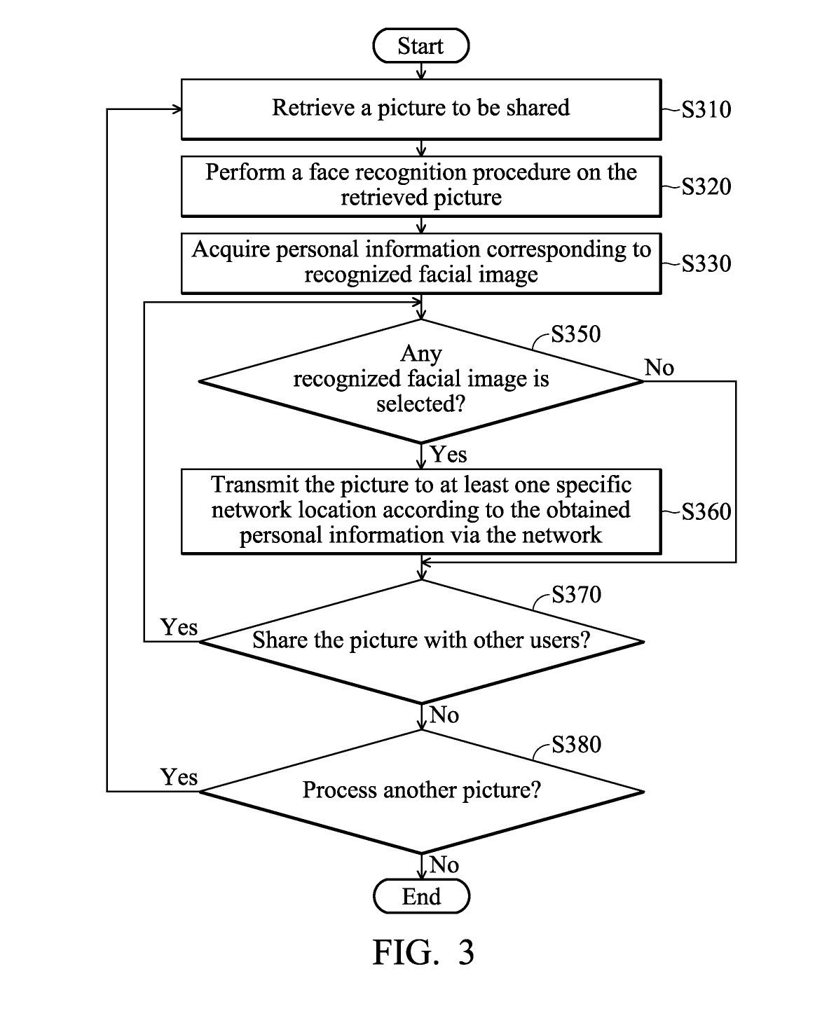

FIG. 3 is a flow chart showing an embodiment of a picture sharing method according to the invention. The method can be applied in the device 100. The portable device 100 may be, for example, a mobile phone, a PDA, a digital camera and so on. In step S310, a picture to be shared is retrieved. In some embodiment, for example, a user may select or retrieve a picture from the storage device 160 to share with other users. It is understood that the picture may also be acquired from an external storage device such as a USB disk or downloaded from the Internet first and then stored to the storage device 160 for user selection. Note that each picture may contain a plurality of facial images. Then, in step S320, a face recognition procedure is performed on the retrieved picture. The face recognition procedure may be performed, for example, according to at least one predefined facial image. In this step, the face recognition module 120 may detect at least one facial image in the retrieved picture and compares the detected facial image with predefined facial images in a database to determine whether it belongs to one of the registered users. For example, if a detected facial image matches a facial image “BOB” in the database, it is recognized that a person whose name is BOB is in the picture. It is understood that, in this embodiment, the database may be located in a local storage, such as within the storage device 160 or located in an external storage device coupled to the device 100, so that the database can be directly accessed, but is not limited thereto. In some embodiments, the database may also be located in a specific location in a connected network, such as the Internet or a 3G wireless network, so that the database can be accessed by the network module 150.

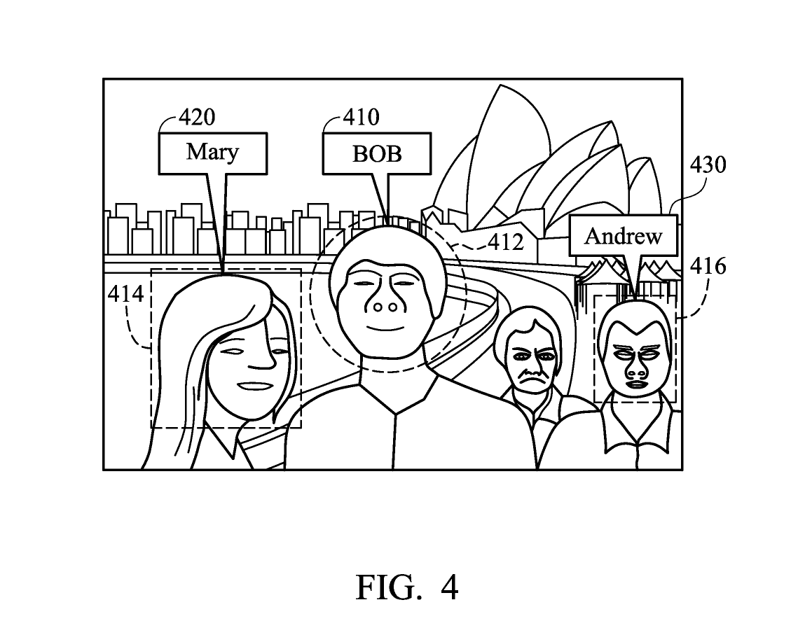

If the detected facial image matches a predefined facial image in the database, that matched facial image is referred to as a recognized facial image. For the recognized facial image, in step S330, personal information corresponding thereto can be acquired and obtained from the database. The personal information may be obtained from a remote database via the network or from a local database. The acquired personal information may comprise a tag data that specifies or describes the predefined facial image (e.g. a name), a shared space, an email address, a Blog or a network photo album of a registered person identified by the predefined facial image. Note that in some embodiments, the recognized facial image and the obtained personal information may correspond to the same one of the at least one predefined facial image. In some embodiments, after personal information of the recognized facial image is obtained, the picture with the tag data can be displayed on a screen, such as the screen of the display module 140. It is understood that the tag data may be acquired from the personal information. In this step, the tag data for recognized facial image can be displayed on a specific location that is close to the corresponding recognized facial image, such as above or under the corresponding recognized facial image. For example, as shown in FIG. 4, a tag data 410 which is titled “BOB” is displayed above a recognized facial image 412, a tag data 420 which is titled “Mary” is displayed above a recognized facial image 414 and a tag data 430 which is titled “Andrew” is displayed above a recognized facial image 416.

Thereafter, in step S350, it is determined whether any recognized facial image is selected. It is understood that the user may issue a sharing request by clicking a recognized facial image and indicating the users with which the picture will be shared. In this case, a sharing request may be received when a touch to a portion of the picture corresponding to the recognized facial image on the screen is detected. For example, referring to FIG. 4, a user may click on the facial image 412 with the tag data “BOB” to issue a sharing request to share the picture with BOB or another predefined user. The processing module 130 may determine that a recognized facial image is selected if the touch panel is used and the recognized facial image is clicked. Note that, in this embodiment, the processing module 130 may ignore the sharing request if a facial image other than the recognized facial image is selected. That is, the sharing request of the picture may be ignored if the selected facial image does not belong to a registered user. In some embodiments, the picture would not be transmitted when a detected touch to a portion of the picture on the screen does not correspond to any recognized facial image.

When it is determined that none of the recognized facial images is selected (No in step S350), step S370 is further performed. When it is determined that at least one recognized facial image is selected (Yes in step S350), it may indicates that the picture is to be shared and thus, in step S360, the processing module 130 transmits the picture to at least one specific network location according to the obtained personal information via the network. Step S360 may run in background. In some embodiments, the processing module 130 may transmit the picture to a specific network location according to a predetermined sending setting via the network module 150. It is to be understood that the sending setting is used to indicate the way the picture is to be sent, e.g. “to E-mail”, “to shared space”, “inform to all” and is configurable. For example, in this embodiment, the processing module 130 may transmit the picture to an e-mail address or a shared space, which can be obtained from personal information, if the setting “to E-mail” or “to shared space” is configured as a default setting. In some embodiments, if the setting “inform to all” is configured as a default setting, the processing module 130 may transmit and store the picture to a specific network location (e.g. a shared space) and send a notification by E-mail to at least one of the recognized registered users in the picture to inform them that a picture has been uploaded and can be downloaded. Note that, in this embodiment, the step of transmitting may not be performed when a detected touch to a portion of the picture on the screen does not correspond to any recognized facial image.

Moreover, a dialog box may be displayed for user to confirm the sharing request or whether to transmit the picture. If confirmed, the picture can be sent in background. The user may confirm the request by pressing a button “Yes” or cancel the request by pressing a button “No”, for example. Note that, in some embodiments, it is possible that more than one recognized facial image are selected at a time.

Step S370 may further be performed. In step S370, it is determined whether to share picture with other users. If yes, the procedure may return to steps S350-S360 to perform another sharing operation. If no (No in step S370), in step S380, it is then determined whether to process another picture. If determined to be Yes, the procedure may return to steps S310 to repeat the procedure. If no pictures are to be processed, the procedure ends.

In one embodiment, the picture sharing method may be performed after the image capture module 110 acquires a picture.

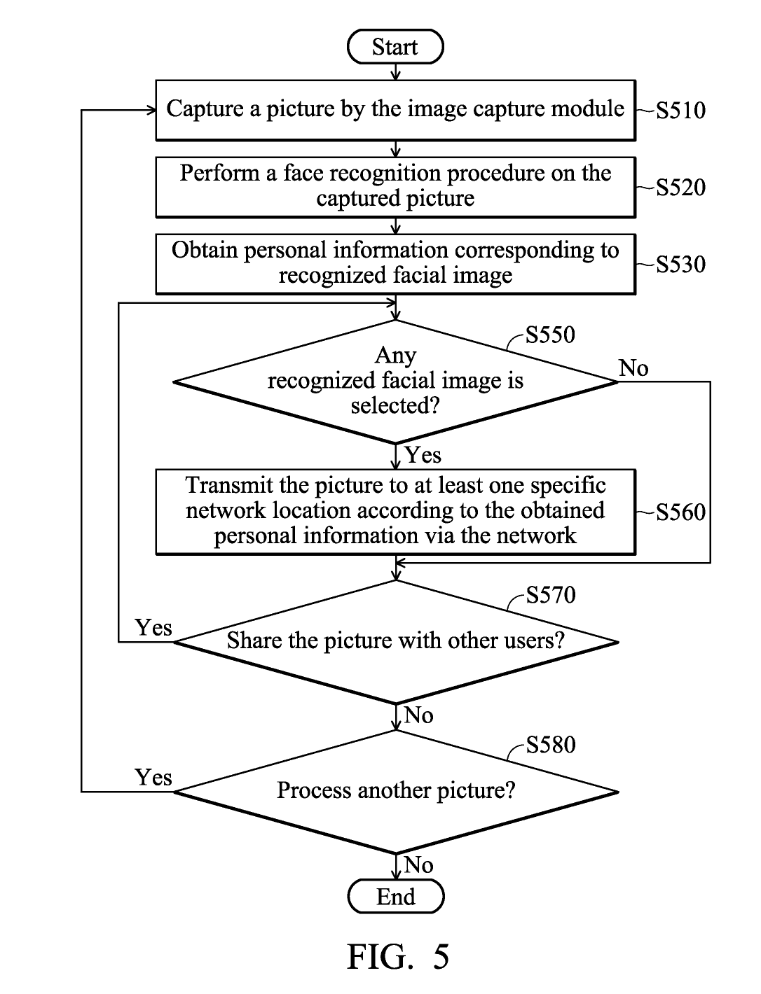

FIG. 5 is a flow chart showing another embodiment of a picture sharing method according to the invention. The method can be applied in the device 100. In step S510, a user captures a picture by, for example, the image capture module 110 and the picture is to be shared with other users. Then, in step S520, a face recognition procedure is performed on the captured picture. Again, the face recognition module 120 may detect at least one facial image in the picture and compare the detected face with predefined facial images in the database to locate matches with registered users.

Again, when a detected facial image matches one of the predefined facial images in the database, the facial image is referred to as a recognized facial image. For recognized facial image, in step S530, personal information corresponding thereto will be obtained from the database. The obtained personal information may comprise a tag data that specifies or describes the predefined facial image (e.g. a name), a shared space, an email address, a Blog or a network photo album of a registered person identified by the predefined facial image. If personal information of the recognized facial image is obtained, in some embodiments, the selected picture with the tag data can be displayed on the screen, such as the screen of the display module 140. In such case, the tag data for recognized facial image can be displayed on a specific location that is close to the corresponding recognized facial image, such as under the corresponding recognized facial image.

Thereafter, in step S550, it is determined whether any recognized facial image is selected. The processing module 130 may determine that a recognized facial image is selected if a touch panel is used and the recognized facial image is clicked.

When it is determined that no recognized facial image is selected (No in step S550), step S570 is further performed. When it is determined that at least one recognized facial image is selected (Yes in step S550), it can mean that the picture is to be shared with other users and thus, in step S560, the processing module 130 may transmit the picture to at least one specific network location (e.g. e-mail address) according to the obtained personal information or a predetermined sending setting via the network module 150. Step S560 may run in background. Note that, in this embodiment, the step of transmitting will not be performed when a detected touch to a portion of the picture on the screen does not correspond to any recognized facial image.

Moreover, a dialog box may be displayed for user to confirm the sharing request or whether to transmit the picture if a recognized facial image is selected. The user may confirm the request by pressing the button “Yes” or cancel the request by pressing the button “No”, for example. Note that, in some embodiments, it is possible that more than one recognized facial images can be selected at a time.

Step S570 may further be performed. In step S570, it is determined whether the picture is to be shared with other users. If yes, the procedure may returns to steps S550-S560 to perform another sharing operation. If no (No in step S570), in step S580, it is then determined whether to process another picture. If another picture is to be processed (Yes in step S580), the procedure returns to step S510 to repeat the procedure. If no, the procedure ends.

In sum, according to the portable device and picture sharing method of the invention, facial image in a picture to be shared can be recognized according to predefined facial images, and then be automatically transmitted to a specific network location indicated by corresponding personal information in background, achieving fast picture sharing. Furthermore, with automatic matching of facial images and personal information, users may easily share picture with each other, simplifying the sharing procedure. Though in the embodiments above, the images to be recognized and the predefined images are facial images, the recognition procedure could also be performed on other types of images such as images of buildings, creatures, landscape, etc. and the picture containing recognized image could also be shared by transmitting to a specific network location.

Picture sharing methods for a portable device connected to a network, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A picture sharing method for a portable device, comprising:
retrieving a picture to be shared;
performing a face recognition procedure on the picture to recognize at least one facial image in the picture;
obtaining personal information corresponding to the recognized facial image; and
transmitting the picture to at least one specific network location according to the obtained personal information via a network.

2. The picture sharing method as claimed in claim 1, further comprising:
displaying the picture on a screen of the portable device;
wherein the step of transmitting the picture comprises transmitting the picture to the specific network location based on the obtained personal information via the network when a touch to a portion of the picture corresponding to the recognized facial image on the screen is detected. {Step S350}

3. The method as claimed in claim 1, wherein the specific network location is an E-mail address, a Blog, a web page or a shared space in the network.

4. The method as claimed in claim 1, wherein the face recognition procedure is performed according to at least one predefined facial image, and the recognized facial image and the obtained personal information correspond to the same one of the at least one predefined facial image.

5. The method as claimed in claim 1, wherein the step of transmitting the picture comprises storing the picture to the specific network location and sending an e-mail to inform at least one user.

6. The method as claimed in claim 2, wherein the step of transmitting is not performed when a detected touch to a portion of the picture on the screen does not correspond to any recognized facial image.

7. The method as claimed in claim 1, wherein the personal information comprises a username, a MSN ID, a Facebook ID, an E-mail address, a Blog, a web page or a shared space in the network or a combination thereof.

8. The method as claimed in claim 1, further comprising:
displaying a dialog box for a user to confirm whether to transmit the picture, wherein if confirmed, the picture is sent in background.

9. The method as claimed in claim 1, wherein the network comprises the Internet.

10. The method as claimed in claim 1, wherein the personal information is obtained from a remote database via the network or from a local database.

11. The method as claimed in claim 1, wherein the portable device is a mobile phone, a personal digital assistant (PDA) or a digital camera.

12. The method as claimed in claim 1, further comprising:
providing a user interface for editing the personal information in a database.

13. A portable device, comprising:
a face recognition module, performing a face recognition procedure to recognize at least one facial image in a picture to be shared;
a processing module, obtaining personal information corresponding to the recognized facial image; and
a network module, transmitting the picture to at least one specific network location according to the obtained personal information via a network.

14. The portable device as claimed in claim 13, wherein the face recognition procedure is performed according to at least one predefined facial image, and the recognized facial image and the obtained personal information correspond to a same one of the at least one predefined facial image.

15. The portable device as claimed in claim 14, wherein the recognized facial image, the obtained personal information and the predefined facial image correspond to a same user.

16. The portable device as claimed in claim 13, wherein the picture to be shared is provided by an image capture module.

17. The portable device as claimed in claim 13, wherein the specific network location is an E-mail address, a Blog, a webpage or a shared space in the network and the personal information comprises a user name, a MSN ID, a Facebook ID, the E-mail address, the Blog, the web page, the shared space in the network or a combination thereof.

18. The portable device as claimed in claim 13, further comprising a user interface for editing personal information in the database.

19. The portable device as claimed in claim 13, wherein the portable device is a mobile phone, a personal digital assistant (PDA) or a digital camera.

20. A picture sharing method for a portable device connected to a network, comprising:
acquiring a picture by an image capture module;
performing a face recognition procedure on the picture to recognize at least one facial image in the picture;
obtaining personal information corresponding to the recognized facial image; and
transmitting the picture to at least one specific network location according to the obtained personal information via the network.
